(19) United States
(12) Patent Application Publication
(10) Pub. No.: US 2024/0030501 A1
(43) Pub. Date: Jan. 25, 2024

(54) ELECTROCHEMICAL CELLS INCLUDING ANODES COMPRISING A PROTECTIVE LAYER, AND RELATED METHODS

(71) Applicant: Battelle Energy Alliance, LLC, ldaho Falls, ID (US)

(72) Inventors: Bin Li, ldaho Falls, ID (US); Corey M. Efaw, Boise, ID (US); Eric J. Dufek, Ammon, ID (US)

(21) Appl. No.: 18/247,577

(22) PCT Filed: Oct. 1, 2021
(86) PCT No.: PCT/US2021/071682

§ 371 Date: Mar. 31, 2023

Related U.S. Application Data
(60) Provisional application No. 63/086,794, filed on Oct. 2, 2020.

(51) Int. Cl. H01M 10/42; H01M 4/04; H01M 4/38; H01M 4/134; H01M 4/1395

(52) U.S. Cl. CPC H01M 10/4235; H01M 4/045; H01M 4/382; H01M 4/134; H01M 4/1395; H01M 2004/027

(57) ABSTRACT

An electrochemical cell is disclosed and comprises an electrolyte between a cathode and an anode and a protective layer between the anode and the electrolyte. The protective layer comprises a porous layer over the anode and a dense layer over the porous layer, each of the porous layer and the dense layer comprising an inorganic compound, an organic compound, or an inorganic-organic composite. Additional electrochemical cells are disclosed. Also disclosed is a method of forming an electrochemical cell.

### CROSS-REFERENCE TO RELATED APPLICATIONS

This application is a national phase entry under 35 U.S.C. § 371 of International Patent Application PCT/US2021/071682, filed Oct. 1, 2021, designating the United States of America and published as International Patent Publication WO 2022/073035 A1 on Apr. 7, 2022, which claims the benefit under Article 8 of the Patent Cooperation Treaty to U.S. Patent Application Ser. No. 63/086,794, filed Oct. 2, 2020.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

The disclosure relates generally to electrochemical cells including a protective layer. More specifically, the disclosure relates to alkali metal ion batteries comprising metal anodes including a multi-layered artificial solid electrolyte interphase (SEI) structure as the protective layer.

### BACKGROUND

Lithium-ion batteries are a form of rechargeable battery often used in electric vehicles and a variety of electronics. Lithium (Li) metal is often considered the most desirable anode material for rechargeable battery technology due to its high theoretical capacity and low electrochemical potential. However, rechargeable Li batteries have not reached their commercial potential due to uneven plating and stripping of Li metal within the batteries, as well as side reactions between Li metal and electrolytes, which causes the formation of a solid electrolyte interphase (SEI) and inactive metallic Li (dead Li). The heterogeneity resulting from the formation of the SEI causes non-uniform current distribution, which leads to both poor efficiency and safety issues from Li dendrite growth. Dendrite growth and inactive metallic Li formation occur over several cycles and cause poor cycle life and safety issues.

Lithium-ion batteries function through the reversible intercalation of Li ions between an anode and a cathode. During this process, electrons flow through an external circuit and may be used for power generation. During charging and discharging, Li ions flow through an electrolyte, which is a material that is conductive to lithium ions, but is insulated from electrons. Li metal, due to its highly reactive nature, reacts where it contacts the electrolyte and forms a heterogeneous surface. Electrolyte decomposition occurs over the first few several charging cycles and forms the SEI. The SEI undesirably functions as a passivating layer on the Li metal (e.g., an electrode), preventing the Li metal from being further consumed by additional reactions with the electrolyte. However, the SEI is fragile. When the SEI is unstable, it may decompose and break due to changing electrode volume, which may cause further consumption of the Li metal as the SEI reforms over additional cycles. This reformation may also cause SEI thickening and electrolyte depletion. These decomposition and reformation processes reduce the cycle life of the lithium-ion battery due to their irreversible consumption of Li metal and electrolyte, leading to reaction inefficiency.

### BRIEF SUMMARY

Embodiments of the disclosure disclosed and taught herein are directed to electrochemical cells including a protective layer over an anode, and methods of forming the electrochemical cells.

An electrochemical cell is disclosed and comprises an electrolyte between a cathode and an anode and a protective layer between the anode and the electrolyte. The protective layer comprises a porous layer over the anode and a dense layer over the porous layer. Each of the porous layer and the dense layer comprises an inorganic compound, an organic compound, or an inorganic-organic composite.

Another electrochemical cell is disclosed and comprises an electrolyte between a cathode and an anode and a protective layer between the anode and the electrolyte. The protective layer comprises a porous layer proximal to the anode and a dense layer adjacent to the porous layer. The porous layer and the dense layer comprise an inorganic compound, an organic compound, or an inorganic-organic composite.

A method of forming an electrochemical cell is also disclosed. The method comprises providing a metal anode and forming a porous layer over the metal anode. An electrolyte is formed over the porous layer and a cathode is formed over the electrolyte. A voltage is applied through the electrochemical cell to form a dense layer on the porous layer.

### BRIEF DESCRIPTION OF THE DRAWINGS

While the specification concludes with claims particularly pointing out and distinctly claiming what are regarded as embodiments of the disclosure, various features and advantages of this disclosure may be more readily ascertained from the following description of example embodiments provided with reference to the accompanying drawings, in which:

FIGS. 1A and 1B are schematics illustrating an electrochemical cell including a protective layer in accordance with embodiments of the disclosure, where FIG. 1B is an enlarged view of the boxed region of FIG. 1A;

FIG. 2 is a schematic illustrating an electrochemical cell including a protective layer in accordance with embodiments of the disclosure, similar to the enlarged view of FIG. 1B;

FIG. 3 is a flow chart illustrating a method of forming an electrochemical cell including a protective layer in accordance with embodiments of the disclosure;

FIG. 4 is a flow chart illustrating a method of forming an electrochemical cell including a protective layer in accordance with embodiments of the disclosure;

FIG. 5 is a graph illustrating the cycling performances of Li metal anodes in accordance with embodiments of the disclosure;

FIG. 6A is a micrograph illustrating the morphological characteristics of a surface of a protective layer in accordance with embodiments of the disclosure;

FIG. 6B is a micrograph illustrating the morphological characteristics of a cross-section of a protective layer in accordance with embodiments of the disclosure;

FIG. 7 is a collection of micrographs illustrating the morphological characteristics of anodes in accordance with embodiments of the disclosure after they were subjected to an increasing number of cycles;

FIG. 8A is a micrograph illustrating the morphological characteristics of a surface of a protective layer in accordance with embodiments of the disclosure; and

FIG. 8B is a micrograph illustrating the morphological characteristics of a cross-section of a protective layer in accordance with embodiments of the disclosure.

### DETAILED DESCRIPTION

An electrochemical cell including an anode having a protective layer is disclosed, as are methods of forming the electrochemical cell including the anode having the protective layer. The protective layer may be an artificial solid electrolyte interphase (SEI) structure that includes a porous layer (e.g., a porous SEI portion, a porous SEI layer) and a dense layer (e.g., a dense SEI portion, a dense SEI layer). The electrochemical cell also includes an electrolyte and a cathode. The protective layer of the electrochemical cell may be formed by forming the porous layer and then forming the dense layer. The dense layer may be formed in-situ or ex-situ.

The following description provides specific details, such as material compositions and processing conditions (e.g., temperatures, pressures, flow rates, etc.) in order to provide a thorough description of embodiments of the disclosure. However, a person of ordinary skill in the art will understand that the embodiments of the disclosure may be practiced without necessarily employing these specific details. Indeed, the embodiments of the disclosure may be practiced in conjunction with conventional systems and methods employed in the industry. In addition, only those process components and acts necessary to understand the embodiments of the disclosure are described in detail below. A person of ordinary skill in the art will understand that some process components (e.g., pipelines, line filters, valves, temperature detectors, flow detectors, pressure detectors, and the like) are inherently disclosed herein and that adding various conventional process components and acts would be in accord with the disclosure.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figure. Unless otherwise specified, the spatially relative terms are intended to encompass different orientations of the materials in addition to the orientation depicted in the figure. For example, if materials in the figure are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used herein, the term “substantially all” means and includes greater than about 95%, such as greater than about 99%.

As used herein, the term “about” in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof.

As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be excluded.

As used herein, the term “anode” and its grammatical equivalents means and includes an electrode where oxidation takes place during a discharge cycle.

As used herein, the term “cathode” and its grammatical equivalents means and includes an electrode where reduction takes place during a discharge cycle.

As used herein, the term “electrolyte” and its grammatical equivalents means and includes an ionic conductor, which can be in a solid state, a liquid state, or a gaseous state (e.g., a plasma).

As used herein, the term “solid electrolyte interphase” and its grammatical equivalents means and includes a material that forms at an anode surface of an electrochemical cell between the anode and the electrolyte. The material may be a substantially continuous layer that is formed between the anode and the electrolyte.

The illustrations presented herein are not meant to be actual views of any particular electrochemical cell (e.g., alkali metal ion battery), anode (e.g., metal anode), current collector, protective layer (e.g., multi-layered artificial SEI structure), or related method, but are merely idealized representations, which are employed to describe example embodiments of the present disclosure. The figures are not necessarily drawn to scale. Additionally, elements common between figures may retain the same numerical designation.

Embodiments of the disclosure include the anode having the protective layer (e.g., the multi-layered artificial SEI structure) thereon and may be used in electrochemical cells to extend battery lifetime (e.g., cycle life) and enhance battery performance (e.g., rate performance) by improving the stability of the anode. The protective layer of the electrochemical cell may include multiple layers. The protective layer may be configured as a substantially continuous layer, a portion of which may be formed in-situ between the anode and the electrolyte. Alternatively, the portion of the protective layer may be formed ex-situ. For example, the protective layer may include the porous layer that contacts a surface of the anode, and another layer of the protective layer may include the dense layer adjacent to (e.g., on, over) the porous layer. The porous layer is in direct contact with the anode and the dense layer is in direct contact with the porous layer. Therefore, the dense layer is between the electrolyte and the porous layer, and the electrolyte is between the dense layer and the cathode in the electrochemical cell. The dense layer of the protective layer exhibits a greater density relative to the density of the porous layer. The porous layer exhibits a greater porosity relative to the porosity of the dense layer. The dense layer of the protective layer is formed in-situ or ex-situ and provides a so-called “closed host” configuration to the electrochemical cell.

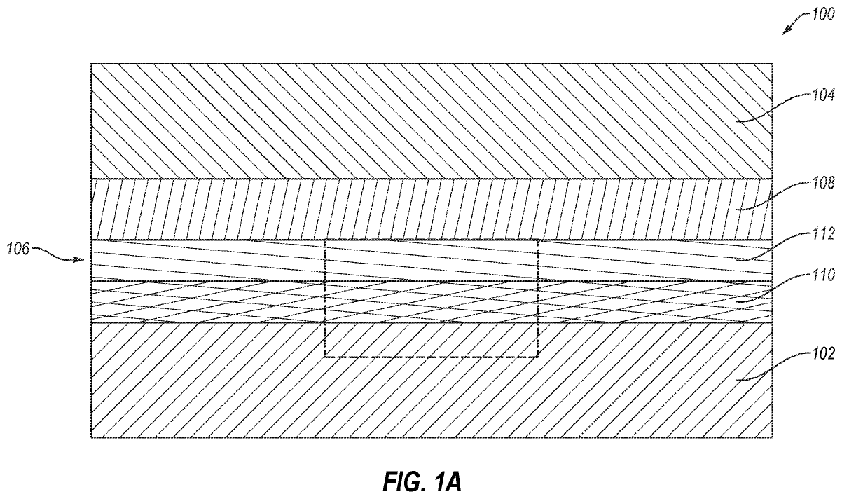

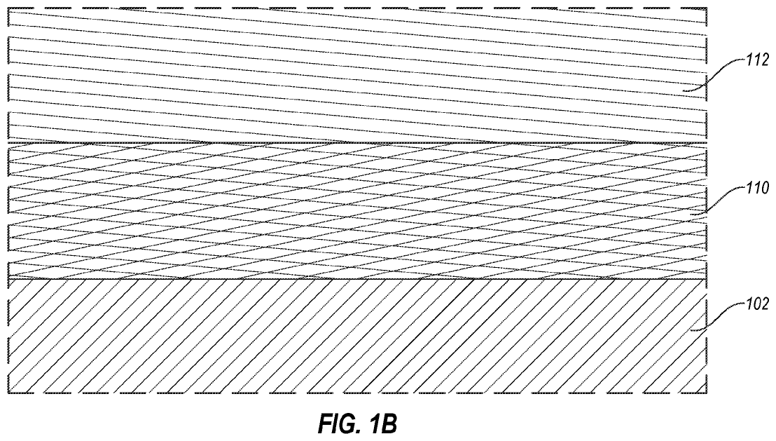

Embodiments of the disclosure will now be described with respect to FIGS. 1A and 1i, which are schematic illustrations of an electrochemical cell 100 including a protective layer 106 (e.g., the multi-layered artificial SEI structure, the SEI structure) in accordance with embodiments of the disclosure. The electrochemical cell 100 includes an anode 102, a cathode 104, the protective layer 106 between the anode 102 and the cathode 104, and an electrolyte 108 between the protective layer 106 and the cathode 104. The protective layer 106 is proximal to the anode 102 and the electrolyte 108 is distal to the anode 102. The protective layer 106 may include, for example, a porous layer 110 proximal to the anode 102 and a dense layer 112 proximal to the electrolyte 108. However, the protective layer 106 may include two or more layers, and each of the layers may individually be porous or dense, with the one or more dense layers being distal to the anode 102. The protective layer 106 may stabilize the anode 102. The electrochemical cell 100 may be, for example, an alkali metal ion battery (e.g., a lithium-ion battery, a sodium-ion battery, a potassium-ion battery, a magnesium-ion battery, a calcium-ion battery), and the anode 102 may be a metal anode (e.g., a Li metal anode, a Na metal anode, a K metal anode, a Mg metal anode, a Ca metal anode). Alternatively, the electrochemical cell as initially formed may be free of an anode (e.g., anode-free) and include a current collector in place of the anode 102. In such an anode-free electrochemical cell 100, the current collector may function as the anode 102 on an anode side of the electrochemical cell 100 after conducting one or more charge/discharge cycles. The current collector may be formed of and include an electrically conductive film, such as a copper current collector, a stainless steel current collector, or a carbon-based current collector such as a graphite-based or nanotube-based current collector.

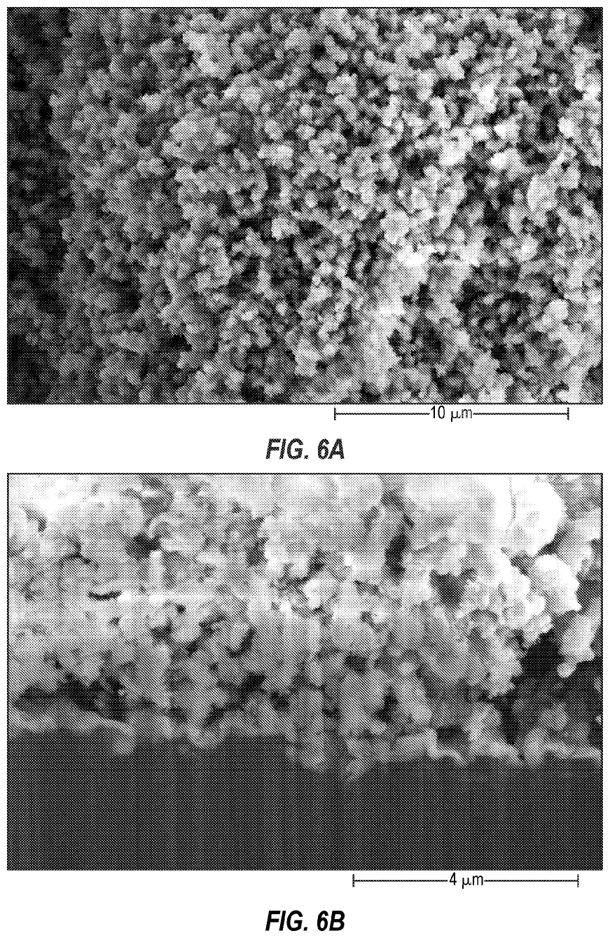

The porous layer 110 of the protective layer 106 may be ionically conductive and include pores (see FIGS. 6A-8B) that are interconnected with one another and define a tortuous pathway through the porous layer 110. The porous layer 110 may include, for example, a porosity of between about 1% by volume and about 90% by volume, such as between about 1% by volume and about 25% by volume, between about 10% by volume and about 90% by volume, between about 20% by volume and about 90% by volume, between about 20% by volume and about 80% by volume, between about 20% by volume and about 70% by volume, between about 20% by volume and about 60% by volume, between about 20% by volume and about 50% by volume, between about 20% by volume and about 40% by volume, between about 30% by volume and about 90% by volume, between about 40% by volume and about 90% by volume, between about 50% by volume and about 90% by volume, between about 60% by volume and about 90% by volume, between about 70% by volume and about 90% by volume, between about 80% by volume and about 90% by volume, between about 40% by volume and about 80% by volume, between about 40% by volume and about 70% by volume, between about 40% by volume and about 60% by volume, or between about 40% by volume and about 50% by volume. In some embodiments, the porous layer 110 includes a porosity of between about 10% by volume and about 90% by volume. If the porous layer 110 is electronically conductive in addition to being ionically conductive, the interconnectedness of pores of the porous layer 110 may be optional. The interconnectedness of the porous layer 110 enables uniform plating and stripping of metal ions in the pores and electronic transportation through the plated metal during use and operation of the electrochemical cell 100.

The porous layer 110 may exhibit a high interfacial energy toward the metal of the anode 102 such that metal of the anode 102 may be formed (e.g., plated) in the pores rather than through the pore walls, the latter of which would damage the pore structures in the porous layer 110. For instance, the porous layer 110 may exhibit a low affinity to the metal ions of the anode 102. The interconnected pores of the porous layer 110 enable the metal of the anode 102 to be formed (e.g., plated, deposited) at the interface between the protective layer 106 and the anode 102, with electrons involved in the reduction/oxidation reaction transported through the plated metal in the porous layer 110. The presence of the pores in the porous layer 110 may provide improved mechanical stability and improved metal ion flux distribution to the protective layer 106. The porous structure of the porous layer 110 provides more interfaces between the protective layer 106 and deposited metal.

The porous layer 110 may include an ionic compound, and may be comprised of an inorganic material and/or an organic material (e.g., an inorganic-organic composite). For example, the inorganic material of the porous layer 110 may be formed of and include a compound such as a lithium salt, including, but not limited to, lithium fluoride (LiF), lithium bromide (LiBr), lithium chloride (LiCl), lithium iodide (LiI), lithium carbonate (LiCO₃), lithium phosphide (Li₃P), lithium phosphate (Li₃PO₄), lithium nitride (Li₃N), lithium nitrate (LiNO₃), lithium sulfide (Li₂S), lithium sulfate (Li₂SO₄), thio-lithium superionic conductors (thio-LISICON), lithium tin phosphorous sulfide (Li₁₀SnP₂Si₂), lithium-stuffed garnet (Li₇La₃Zr₂O₁₂), perovskite-type lithium lanthanum titanates (Li₃ₓLa_{(2x/3)}TiO₃), sodium superionic conductors (NASICON), lithium aluminum titanium phosphate (Li_{1.3}Al_{0.3}Ti_{1.7}(PO₄)₃), glass-ceramics (e.g., sulfide glass-ceramics such as XLi₂S-(1-X)P₂S₅), or a combination thereof. In some embodiments, the inorganic material includes LiF and LiI. The porous layer 110 may also include relatively smaller amounts of native oxide products (e.g., Li₂O, Li₂CO₃), byproducts (e.g., products formed by reaction with a polymer, such as carbofluorides), and/or lithium iodide (LiI).

As another example, the porous layer 110 may be formed of and include an organic material such as a polymer. The polymer may be a conductor of the metal ions. The polymer of the organic material of the porous layer 110 may include the molecular formulae shown below (e.g., the polymer may be polyethylene oxide (PEO)-based, polyvinylchloride (PVC)-based, etc.).

| Polymer matrix | Molecular formula |
|---|---|
| PEO | 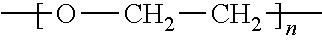 |
| PVC | 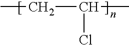 |
| PAN | 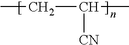 |
| PMMA | 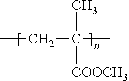 |
| PVDF | 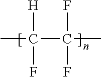 |
| PVDF-HFP | 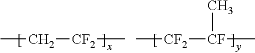 |
| PPG | 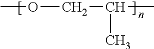 |
| PDMS | 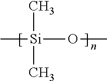 |
| PEC | 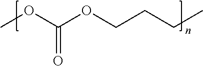 |
| PPC | 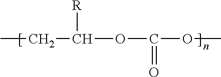 |
| PCL | 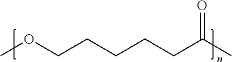 |
| PTMC | 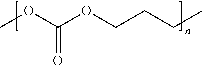 |

As another example, the porous layer 110 may be a polymer-based composite, such as a polymer/inert ceramic, a polymer/fast-ion conductor, a polymer/ionic liquid, a polymer/metal-organic framework (MOF), a polymer/cellulose composite, or a combination thereof.

If the porous layer 110 includes the inorganic-organic composite, the porous layer 110 may include a greater portion of the inorganic material relative to other components of the porous layer 110, such as to the organic material. The porous layer 110 may, therefore, be referred to herein as being “rich” in the inorganic material. The porous layer 110 may include, for example, greater than or equal to about 51% of the inorganic material. In some embodiments, the porous layer 110 is an inorganic-organic composite that includes LiF and PVDF, and is LiF-rich. In such a situation, although the porous layer 110 may include LiF, which has low ionic conductivity, metal ion transport through the protective layer 106 of the electrochemical cell 100 may be increased relative to that of a conventional electrochemical cell.

Further, the porous layer 110 may exhibit a thickness in a range from about 0.5 micrometer to about 15 micrometers, such as from about 1 micrometers to about 15 micrometers, from about 1 micrometers to about 10 micrometers, from about 3 micrometers to about 10 micrometers, or from about 5 micrometers to about 6 micrometers. As shown in FIG. 1B, which is an enlarged view of the boxed region in FIG. 1A, a relative thickness of the porous layer 110 may be greater than a thickness of the dense layer 112. Additionally, the pores in the porous layer 110 may have a mean pore size ranging from about 10 nanometers to about 1000 nanometers, such as from about 50 nanometers to about 700 nanometers or from about 500 nanometers to about 600 nanometers. In some embodiments, the pores in the porous layer 110 are about 550 nanometers. The size of the pores and the thickness of the porous layer 110 may be tailored to achieve the desired characteristics of the porous layer 110 in order to tailor properties of the porous layer 110. The dense layer 112 may be ionically conductive, electrically insulating, and of a sufficient density to substantially reduce or prevent consumption of active materials (e.g., the metal of the anode 102, the electrolyte 108) during use and operation of the electrochemical cell 100. The dense layer 112 may exhibit a porosity of less than about 20% by volume. Since the dense layer 112 is formed over the porous layer 110, the dense layer 112 may provide a so-called “closed host” configuration to the electrochemical cell 100 in that the metal of the anode 102 is not exposed to the electrolyte 108. The dense layer 112 may be formed of and include an inorganic compound and/or an organic compound, such as Li₂S, LiₓSO_{y}, LiₓNO_{y}, LiF, Li₃P, Li₃PO₄, carbides, oxides, any of the materials described above with respect to the porous layer 110, or a combination thereof. For example, the dense layer 112 may include thio-lithium superionic conductors (thio-LISICON), lithium tin phosphorous sulfide (Li₁₀SnP₂Si₂), lithium-stuffed garnet (Li₇La₃Zr₂O₁₂), perovskite-type lithium lanthanum titanates (Li₃ₓLa_{(2x/3)}TiO₃), sodium superionic conductors (NASICON), lithium aluminum titanium phosphate (Li_{1.3}Al_{0.3}Ti_{1.7}(PO₄)₃), sulfide glass-ceramics (e.g., XLi₂S-(1-X)P₂S₅), or a combination thereof. Alternatively, the dense layer 112 may include an organic material such as a polymer. The polymer may include the molecular formulae shown above (e.g., the polymer may be polyethylene oxide (PEO)-based, polyvinylchloride (PVC)-based, etc.). The dense layer 112 may also be a polymer-based composite, such as a polymer/inert ceramic, a polymer/fast-ion conductor, a polymer/ionic liquid, a polymer/metal-organic framework (MOF), a polymer/cellulose composite, or a combination thereof. During use and operation of the electrochemical cell 100, the dense layer 112 may remain flexible (e.g., supple). Therefore, cracking and other defects in the dense layer 112 may be minimized.

The dense layer 112 may include a greater portion of the inorganic material relative to other components of the dense layer 112, such as to the organic material. The dense layer 112 may, therefore, be referred to herein as rich in the inorganic material. The dense layer 112 may include, for example, greater than or equal to about 51% of the inorganic material. In some embodiments, the dense layer 112 is formed in-situ on an upper surface of the porous layer 110, as described below. In other embodiments, the dense layer 112 is formed ex-situ on an upper surface of the porous layer 110, as described below. In some embodiments, the dense layer 112 includes the inorganic-organic composite, such as a LiF/PVDF layer.

As shown in FIG. 1B, a relative thickness of the dense layer 112 may be less than the thickness of the porous layer 110. The dense layer 112 may be of sufficient thickness to insulate and protect the underlying porous layer 110 and the anode 102. The increased thickness of the porous layer 110 compared to the dense layer 112 does not cause a drastic increase in impedance, as the interface is more ionically conductive. The dense layer 112 may exhibit, for example, a thickness of less than or equal to about 1 micrometer (1000 nm). For example, the dense layer 112 may have a thickness in a range from about 5 nanometers to about 1000 nanometers, such as from about 500 nanometers to about 999 nanometers, from about 20 nanometers to about 500 nanometers, from about 20 nanometers to about 400 nanometers, from about 20 nanometers to about 300 nanometers, from about 20 nanometers to about 200 nanometers, from about 20 nanometers to about 100 nanometers, or from about 20 nanometers to about 50 nanometers. The thickness may be tailored to achieve the desired characteristics of the dense layer 112 in order to tailor properties of the protective layer 106. The dense layer 112 may have a porosity that is less than about 5%. After formation, the dense layer 112 may include substantially no native species and may be substantially homogeneous in composition.

Without being bound by any theory, the pores of the porous layer 110 are believed to provide increased numbers of interfaces, such as Li/LiF interfaces, which may reduce local volume fluctuations and improve metal ion diffusion along the interfaces. The pores of the porous layer 110 are also believed to provide uniform metal ion flux distribution and mechanically suppress dendrite propagation. It is believed that the metal of the anode 102 may percolate through the tortuous and interconnected pores of the porous layer 110. Walls of the pores are not penetrated or damaged due to the high interfacial energy. Therefore, the interconnected porous structure of the porous layer is retained during use and operation of the electrochemical cell. As the metal ions of the anode 102 are deposited in the pores during plating, an exposed upper region of the plated metal in the porous layer 110 is consumed via reaction with the electrolyte 108, forming the protective layer 106 including the porous layer 110 and the dense layer 112. The resulting relatively dense, inorganic-rich protective layer 106 drastically reduces reactions between metal ions of the anode 102 and the electrolyte 108. The dense layer 112 has no native species and is relatively homogeneous, which may benefit uniform flux of the metal ions. As cycling continues, the pathway for fast transport of the metal ions is through the interconnected pores and interfaces.

The chemical compositions of the porous layer 110 and the dense layer 112 may be similar (e.g., each may be an organic material, an inorganic material, or an organic-inorganic composite) or may be different from one another as long as the chemical composition is conductive to metal ions, such as being conductive to lithium ions. In some embodiments, each of the porous layer 110 and the dense layer 112 is an organic-inorganic composite. The inorganic-organic composite of the porous layer 110 and of the dense layer 112 may exhibit, however, different material compositions.

The electrolyte 108 may be a solid electrolyte or a liquid electrolyte, such as a low-concentration electrolyte or a high-concentration electrolyte. The electrolyte 108 may optionally include an additive, such as lithium nitrate (LiNO₃), to further stabilize the protective layer 106 and the anode 102. The low-concentration electrolyte may include a concentration of less than 4 mol/L and the high-concentration electrolyte may include a concentration greater than or equal to about 4 mol/L. The electrolyte 108 may include the high-concentration electrolyte, such as 4 M lithium bis(fluorosulfonyl)imide (LiFSI) in dimethoxyethane (DME) and/or a localized high-concentration electrolyte, such as 1 M LiFSI in DME: tris(2,2,2-trifluoroethyl)orthoformate (TFEO) (1:9 weight percent). The electrolyte 108 may include, for example, lithium bis(trifluoromethanesulfonyl)imide (LiTFSI) in dioxolane (DOL) and dimethoxyethane (DME) with lithium nitrate (LiNO₃). As another example, the electrolyte 108 may include lithium hexafluorophosphate (LiPF₆) in ethylene carbonate (EC) and ethyl methyl carbonate (EMC) with fluoroethylene carbonate (FEC) and/or vinylene carbonate (VC). The electrolyte 108 may include 1.2 M LiPF₆ in 3:7 weight percent EC:EMC and 10 weight percent FEC.

The cathode 104 may include any cathodic materials known in the art. For example, the cathode 104 may include sulfur, air (02), a metal oxide (such as nickel-manganese-cobalt oxide (NMC), lithium nickel cobalt aluminum oxide (NCA), lithium manganese oxide (LMO), lithium iron phosphate (LiFePO₄), lithium cobalt oxide (LiCoO₂), lithium nickel manganese cobalt oxide (LiNiₓMn_{y}Co_{1-x-y}O₂), lithium titanate (Li₂TiO₃)), a sulfide, a sulfurized poly(acrylonitrile) (S₈(C₃H₃N)ₙ) or a combination thereof. In some embodiments, the cathode 104 includes a sulfur cathode.

In some embodiments, the electrochemical cell 100 includes a LiF-rich porous layer 110, a LiF-rich dense layer 112, a sulfur cathode, and an electrolyte 108 including LiNO₃.

To form the electrochemical cell 100, the protective layer 106 may be formed over the anode 102 by forming the porous layer 110 over the anode 102 and then forming the dense layer 112 in-situ or ex-situ over the porous layer 110. The anode 102 may be formed by conventional techniques including, but not limited to, physical vapor deposition (PVD), chemical vapor deposition (CVD), or atomic layer deposition (ALD). The porous layer 110 may be formed ex-situ by any suitable technique that achieves the desired degree of porosity. By way of example only, the porous layer 110 may be formed by PVD, CVD, ALD, dip-coating, spin-coating, or a combination thereof. The porous layer 110 may be formed, for example, by exposing the anode 102 to a precursor solution including a polymer, a halogen compound, and an organic solvent. The porous layer 110 may be formed by exposing a surface of the anode 102 to the polymer and the halogen compound dissolved in the organic solvent. By way of example only, the porous layer 110 may be formed from the precursor solution that includes the polymer, the halogen compound, and the organic solvent. The organic solvent may be N,N-dimethylformamide (DMF), dimethoxyethane (DME), 1-methyl-2-pyrrolidone (NMP), 1,3-dioxolane (DOL), or N,N-dimethylacetamide (DMA). However, other organic solvents formulated to dissolve the halogen compound may be used. The halogen compound may be an inorganic compound that is soluble in the organic solvent. The inorganic compound (e.g., LiI) may be formed by reacting an alkali metal, such as Li, with a halogen (e.g., I₂). The precursor solution and the inorganic compound may be reacted with the anode 102 to form the porous layer 110.

In some embodiments, the polymer is PVDF, the alkali metal is lithium, the halogen compound is iodine (I₂), and the organic solvent is DMF. In other embodiments, the polymer is PVDF, the alkali metal is lithium, the halogen compound includes I₂ and LiF, and the organic solvent is DMF. The porous layer 110 may comprise, for example, a matrix rich in inorganic compounds (e.g., LiF) that is produced by reacting a polymer (e.g., PVDF) and an alkali metal (e.g., Li) in an organic solvent (e.g., DMF), and a dissolvable inorganic compound (e.g., LiI) may be formed by reacting an alkali metal with a halogen (e.g., I₂). The porous layer 110 may be formed by dissolving the dissolvable inorganic compound (e.g., LiI) from the inorganic compound matrix (e.g., the LiF-rich matrix) by rinsing the anode 102 with an organic solvent (e.g., DOL:DME). Alternatively, the porous layer 110 may be formed by exposing the anode 102 to the electrolyte 108, causing dissolution of the dissolvable inorganic compound (e.g., LiI).

The porosity of the porous layer 110 may be tailored by altering the amount of dissolvable inorganic compound formed during the formation of the porous layer 110. For example, the porosity may be tailored by increasing or decreasing the amount of halogen (e.g., iodine) present as the reactant, leading to increased formation of the dissolvable inorganic compound (e.g., lithium iodide) in the protective layer 106. If larger amounts of the dissolvable inorganic compound are formed, then larger amounts may be dissolved upon exposure to the electrolyte 108, resulting in a porous layer 110 having increased porosity.

The dense layer 112 may be formed in-situ by exposing the porous layer 110 to the electrolyte 108, forming the cathode 104 over the electrolyte 108, and cycling (e.g., charging and discharging) to produce the dense layer 112 of the electrochemical cell 100. By cycling (e.g., charging and discharging) the electrochemical cell 100 a small number of times after contacting the porous layer 110 with the electrolyte 108 and forming the cathode 104 over the electrolyte 108, the dense layer 112 may be formed in-situ. Alternatively, the dense layer 112 may be formed ex-situ over the porous layer 110 by conventional techniques and the cathode 104 formed over the dense layer 112. The dense layer 112 may be formed by conventional techniques, such as PVD, CVD, ALD, dip-coating, spin-coating, or a combination thereof. Since the dense layer 112 forms an upper portion of the protective layer 106, the dense layer 112 protects the anode 102. By positioning the dense layer 112 over the porous layer 110 (i.e., as the upper portion of the protective layer 106), consumption of the active materials of the electrochemical cell 100 may be substantially reduced or eliminated during subsequent use and operation of the electrochemical cell 100. By forming the protective layer 106 including the porous layer 110 and the dense layer 112, the anode 102 is protected from decomposition and exhibits improved cycling performance. Consequently, the protective layer 106 according to embodiments of the disclosure may be used to enhance the performance of the electrochemical cell 100 containing the protective layer 106.

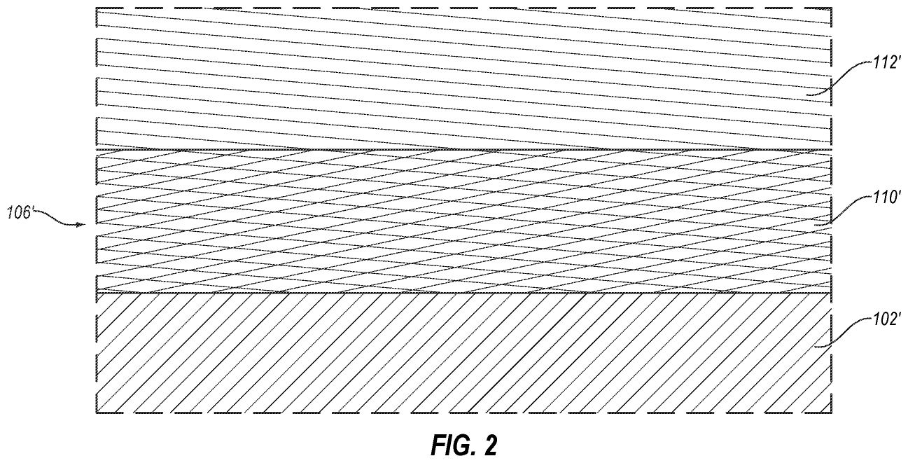

During the cycling, the dense layer 112 may form over the top of the porous layer 110. As such, a clear border (e.g., an interface) between the dense layer 112 and the porous layer 110 may not be present. Rather, the border may appear as an interphase that may look amorphous. The resulting dense layer 112′ may fill in (e.g., infiltrate) the pores of the porous layer 110, as shown schematically in FIG. 2 by the porous layer 110′. The dense layer 112′ may partially fill the pores of the porous layer 110′ or may entirely fill the pores of the porous layer 110′. By filling the pores, the protective layer 106′ of the electrochemical cell 100 may be resistant to cracking. As a result, the porosity of the porous layer 110′ may be between about 1% and about 25% after conducting the initial cycling to produce the dense layer 112′, and more particularly between about 1% and about 10% (e.g., about 5%). The protective layer 106′ may thus have improved cyclability because the protective layer 106′ resists rupture from the large volume fluctuations that the anode 102′ undergoes during operation of the electrochemical cell 100. The porosity of the porous layer 110′ may make available an increased number of interfaces for nucleation of the metal ions are, thus reducing local volume fluctuations and improving the flexibility of the electrochemical cell 100.

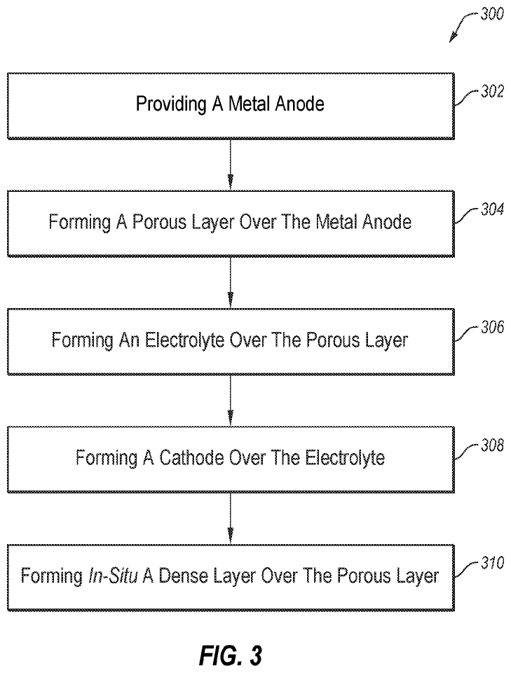

A flow chart illustrating a method 300 of forming the electrochemical cell 100 (e.g., an alkali metal ion battery, a lithium-ion battery) including the anode 102 (e.g., a metal anode, a Li metal anode) having the protective layer 106 (e.g., the multi-layered artificial SEI structure) in accordance with embodiments of the disclosure is shown in FIG. 3. The method includes the act 302 of providing a metal anode, the act 304 of forming a porous layer over the metal anode, the act 306 of forming an electrolyte over the porous layer, the act 308 of forming a cathode on the electrolyte, and the act 310 of forming in-situ a dense layer on the porous layer. Alternatively, the current collector is provided in place of the anode 102 and the acts 304, 306, 308, 310 are conducted as previously described.

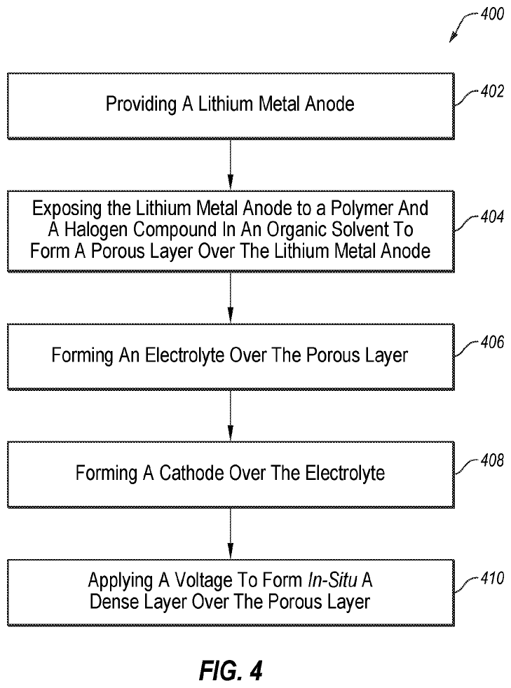

Embodiments of the disclosure will now be described with reference to FIG. 4, which is a flow chart illustrating a method 400 of forming the electrochemical cell 100 as a lithium-ion battery including the anode 102 (e.g., a Li metal anode) having the protective layer 106 (e.g., the multi-layered artificial SEI structure) in accordance with embodiments of the disclosure. As shown in act 402, the method 400 of forming the electrochemical cell 100 may include the act 402 of providing a lithium metal anode and the act 404 of exposing (e.g., contacting) the lithium metal anode to a polymer (e.g., a fluoropolymer, such as polyvinylidene difluoride (PVDF)) and a halogen (e.g., iodine (I₂)) in an organic solvent (e.g., dimethylformamide (DMF), DOL, DME) to form the porous layer 110 on the anode 102. The porosity of the porous layer 110 may be easily adjusted by adjusting process conditions. For example, the porous layer 110 may comprise a matrix rich in inorganic compounds (e.g., LiF) that is produced by reacting a polymer (e.g., PVDF) and an alkali metal (e.g., Li) in an organic solvent (e.g., DMF), and a dissolvable inorganic compound (e.g., LiI) may be formed by reacting an alkali metal with a halogen (e.g., I₂). The porous layer 110 may be formed by dissolving the dissolvable inorganic compound (e.g., LiI) from the inorganic compound matrix (e.g., the LiF-rich matrix) by rinsing the anode 102 with an organic solvent (e.g., DOL:DME). Alternatively, the porous layer 110 may be formed by exposing the treated anode 102 to the electrolyte 108, causing dissolution of the dissolvable inorganic compound (e.g., LiI). The porosity may be tailored by altering the amount of dissolvable inorganic compound formed during the formation of the porous layer. For example, the porosity may be tailored by increasing or decreasing the amount of halogen (e.g., iodine) present as the reactant, leading to increased formation of the dissolvable inorganic compound (e.g., lithium iodide) in the protective layer 106. If larger amounts of the dissolvable inorganic compound are formed, then larger amounts may be dissolved upon exposure to the electrolyte 108, resulting in a porous layer 110 having increased porosity. The porous layer 110 may be one of the materials described above and may be formed to exhibit a thickness and a porosity as described above.

The method 400 may further include the act 406 of forming the electrolyte 108 over the porous layer 110. The electrolyte 108 may include, for example, LiTFSI in DOL/DME with LiNO₃. In act 408, the cathode 104 may be formed over the electrolyte 108. The cathode 104 may include any cathodic material known in the art. The dense layer 112 may be formed in-situ during cycling of the electrochemical cell 100 as shown by act 410. In act 410, a voltage is applied and cycled through the electrochemical cell 100 (i.e., charging and discharging the electrochemical cell 100), which forms the dense layer 112 on the porous layer 110, such as over the top of the porous layer 110. As such, a clear border (e.g., an interface) between the dense layer 112 and the porous layer 110 may not be present. Rather, the border may appear as an interphase that may look amorphous. During initial cycling, metal sites near the electrolyte 108 are consumed to form the dense layer 112, which is electrically insulating and achieves the closed host configuration. The dense layer 112 reduces side reactions and enables extended cyclability on the anode side the electrochemical cell 100. In some embodiments, the dense layer 112 may fill in (e.g., infiltrate) the pores of the porous layer 110. The dense layer 112 may partially fill the pores of the porous layer 110 or may entirely fill the pores of the porous layer 110. As a result, the porosity of the porous layer 110 may be between about 1% and about 25%, and more particularly between about 1% and about 10% (e.g., about 5%). The protective layer 106 may thus have improved cyclability because the protective layer 106 resists rupture from the large volume fluctuations that the anode 102 undergoes during operation of the electrochemical cell 100.

During use and operation of the electrochemical cell 100, the metal of the anode 102 may be plated at in interface between the anode 102 and the protective layer 106 or between the current collector and the protective layer 106. For instance, if the anode 102 is formed of lithium metal, lithium may be deposited. The presence of the protective layer 106 may prevent or reduce fracture, guide Li+ flux, and ensure uniform plating and stripping of Li. If the pores are interconnected, the Li is deposited at the interface of the Li/protective layer or current collector/protective layer and electrons involved in the reduction/oxidation reaction are transported through the deposited Li metal. Without being bound by any theory, it is believed that the lithium of the anode 102 may percolate through the tortuous and interconnected pores of the porous layer 110. Walls of the pores are not penetrated or damaged due to the high interfacial energy with LiF and, therefore, retain the interconnected porous structure. As the lithium of the anode 102 is formed through the pores during plating, an exposed upper region of the plated metal in the porous layer 110 is consumed via reaction with the electrolyte 108, forming the protective layer 106 including the porous layer 110 and the dense layer 112.

Some conventional solutions to extend cycle lifetimes have tried creating an artificial SEI on the surface of a Li electrode to inhibit the formation of dendrites and inactive Li. However, this has failed to meet the needs of the industry because cracking often occurs in the SEI layers due to the large volume change caused by Li plating and stripping, which induces gradual electrolyte consumption and increases cell impedance, causing diminished battery lifetimes. In contrast, the electrochemical cell 100 including the protective layer 106 on the anode 102 according to embodiments of the disclosure has several advantages compared to the conventional SEI structures. First, the porous layer 110 of the protective layer 106 may be quickly, easily, and economically formed by pre-treating the surface of the anode 102 with the polymer and the halogen compound in organic solvents. Further, the porosity may be easily adjusted by adjusting process conditions. For example, the porous layer 110 may comprise a matrix rich in inorganic compounds that is produced by reacting a polymer (e.g., a fluoropolymer) and an alkali metal in organic solvents, and a dissolvable inorganic compound may be formed by reacting an alkali metal with a halogen. The porous matrix may be formed by dissolving the dissolvable inorganic compound from the inorganic compound matrix. The porosity may be tailored by altering the amount of dissolvable inorganic compound formed during the formation of the porous layer. Second, the porous layer 110 may mechanically prevent dendrite growth and act as a buffer to reduce volume change of the anode 102 during plating and stripping of metal ions. As a result, cracking that is observed with conventional SEIs is substantially reduced or prevented with the protective layer 106 according to embodiments of the disclosure. Finally, the dense layer 112 adjacent to (e.g., on top of) the porous layer 110 may inhibit the reaction between the anode 102 and the electrolyte 108. As a result, further decomposition of the electrolyte 108 or the electrolyte reaction with the anode 102 may be prevented and a stable SEI structure may be maintained. Consequently, the cycle lifetime of the electrochemical cell 100 including the protective layer 106 according to embodiments of the disclosure may be increased and the electrochemical cell performance may be enhanced.

The following examples serve to further illustrate embodiments of the disclosure in more detail. These examples are not to be construed as being exhaustive or exclusive as to the scope of this disclosure.

### EXAMPLES

### Example 1

### Anode Formation

Lithium foil (170 μm, MTI Corporation) was punched into ˜1.43 cm diameter disks and rolled onto spacers. The samples were gently polished at two perpendicular directions for 5 seconds each way to remove native film. A mixed SEI film of LiI and LiF was produced from reaction of the polished lithium and a precursor solution. The precursor solution was made by adding 50 mg of polyvinylidene fluoride (PVDF, Sigma-Aldrich, MW-534,000) and 66 mg of iodine (Fisher Scientific) to 10 mL N,N-dimethylformamide (DMF, Sigma-Aldrich), producing a 1:3 I:F ratio solution. Varying the amount of iodine in the precursor solution produced different I:F ratios (22 mg for 1:9 I:F, 40 mg for 1:5 I:F, and 198 mg for 1:1 I:F). The precursor solution was applied to the polished lithium to form the porous PVDF/LiI and LiF layer on the polished lithium.

The artificial SEI was deposited by placing a ˜1.59 cm diameter CELGARD® 2325 separator wetted with the precursor solution onto the polished lithium foil for 3-5 seconds. Removal of LiI from the artificial SEI and formation of the porous LiF SEI is done by rinsing the surface with equal parts 1,3-dioxolane (DOL, Sigma-Aldrich) and dimethoxyethane (DME, Sigma-Aldrich) solvent, followed by drying in a glovebox.

Lithium foil was exposed to a polypropylene/polyethylene (PP/PE) material (e.g., CELGARD® 2325) that was wetted with 12-PVDF-DMF reactant. The PP/PE material was left on the lithium foil for between about 1 second and about 10 seconds (e.g., about 3 seconds and about 5 seconds), and was then removed. The reaction formed LiI and LiF on the surface of the lithium foil. The porous layer was formed by exposing the anode to an electrolyte.

The porous layer may alternatively be formed by rinsing the anode with DOL:DME, where rinsing involves spraying the solvent onto the electrode for between about 3 seconds and about 5 seconds and then drying the electrode with a lint-free wipe. The dense layer was formed in-situ during the cycling of the electrochemical cell.

### Example 2

### Cathode Formation

A sulfur cathode was produced by mixing 1.28 g sulfur (Fisher Scientific, 99.5%) with 0.52 g super P (EQ-Lib-SuperP, MTI Corporation) conductive agent. This mixture was ball milled and further heat treated at 155° C. in an autoclave. 0.2 g PVDF binder mixed in 1-methyl-2-pyrrolidone (NMP, Sigma-Aldrich, >99%) solution was added to the S-C mix with an additional 5 g of NMP solvent, mixed with three 5 mm diameter zirconia balls in an ARE-310 Thinky Mixer for 5 minutes, resulting in 64% active mass. The slurry was rolled onto a 20 m carbon-coated Al current collector (MTI Corporation) and dried in a furnace with dry air flow at 80° C. for three days. The resultant electrode had 3 mg/cm² of active sulfur weight with a porosity of 80-90%. The practical capacity for 1 C of this sulfur is defined as 1000 mA/g (i.e., 3 mAh/cm²). LiFePO₄ (LFP) cathode was purchased from BASF. An active mass of 85 wt. % is confirmed, with inclusion of 7.5% PVDF binder and 7.5% carbon black. Practical capacity of LFP is defined as 2.4 mAh/cm², with a mass loading of 13.97 mg/cm² (˜172 mA/g). Both cathodes were punched into 1.27 cm diameter disks and dried in vacuum prior to loading into glovebox for cell construction.

### Example 3

### Characterization and Analysis of Anodes

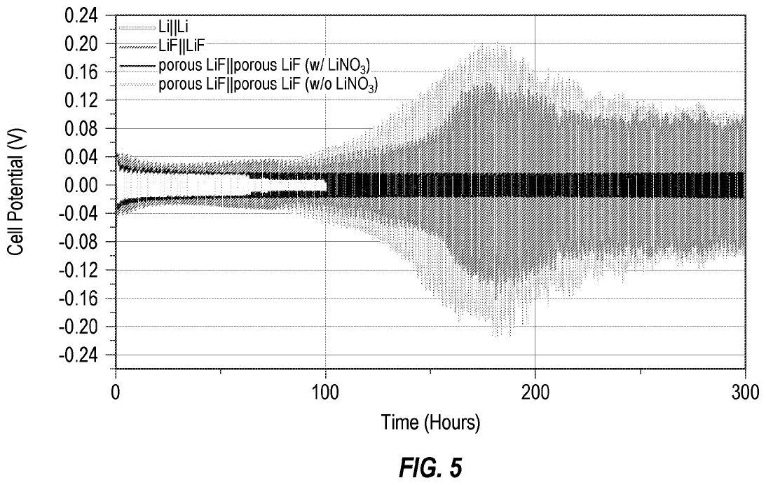

Characterization and analysis techniques were utilized to measure properties of Li metal anodes having a protective layer (e.g., a multi-layered artificial SEI structure) in accordance with embodiments of the disclosure, and to measure how the Li metal anodes compared with other (e.g., conventional) anodes. The cycling performances of the Li metal anodes were analyzed to evaluate the Li metal anode surface stability. The cycling tests were performed in accordance with conventional techniques. FIG. 5 is a graph illustrating the cycling performances of different Li metal anodes. To obtain the cycling performances, galvanostatic cycling of symmetric coin cells was performed with a MACCOR Model 2200 (Maccor, Inc.). 32 μL of 1M lithium bis(trifluoromethanesulfonyl)imide (LiTFSI, BASF) and 2 wt. % of lithium nitrate (LiNO₃, Sigma-Aldrich) mixed in equal parts 1,3-dioxolane (DOL, Sigma-Aldrich) and dimethoxyethane (DME, Sigma-Aldrich) was used as the electrolyte in each coin cell. LiNO₃ was excluded from some coin cells to observe the effect of the additive on the cycling performance of the different anodes.

A bare Li metal anode, a dense LiF metal anode, and a porous LiF metal anode were analyzed in a symmetric cell build with and without LiNO₃ in the electrolyte. The symmetric cell excluded a common cathode material from the positive side of the battery. Instead, it used a similar anode on both the negative and positive sides of the battery. This symmetric anode usage isolated any failure mechanisms to the lithium treatment, excluding any issues observed with cathode (e.g., capacity fade, shuttling effect, etc.). FIG. 5 shows cycling of symmetric cells at a current density and capacity of 1 mA/cm²-1 mAh/cm², respectively. The data indicated that the failure mechanism of conventional, single-component artificial SEI cells (e.g., cells including a dense LiF SEI) shifted to failure via increased cell impedance (e.g., SEI build-up) rather than via short circuiting, as was seen with bare lithium. This revealed that the dense LiF SEI led to reduced dendrite propagation. For the dense LiF SEI, cell impedance was observed to gradually increase after around 50 cycles (e.g., about 100 hours), which was caused by the cracking of the protective layer (e.g., SEI layer), resulting in in greater electrolyte consumption and thicker SEI formation. Additionally, a reduction in cell potential range was observed with the porous LiF metal anode. Unlike with the dense LiF SEI, the porous LiF SEI was capable of maintaining stability despite the large lithium electrode volume fluctuations, as evidenced by the stable voltage hysteresis (e.g., cell potential range) over numerous cycles. The porous LiF SEI was formed through the dissolution of LiI, leaving behind pores. Without being bound by any theory, it is believed that this dissolution left behind a porous layer in the artificial SEI, theoretically producing easier ionic pathways and resulting in decreased cell overpotential. Dissolution was confirmed with high-resolution surface characterization techniques (e.g., X-ray photoelectron spectroscopy (XPS)) and cryogenic scanning electron microscopy equipped with a focused ion beam (cryo-FIB-SEM).

Unexpectedly, symmetric cell electrodes rinsed with solvent prior to testing retained superior cell performance. Though this dissolution was expected to lead to increased available sites for dendritic growth, the growth of dendrites was unexpectedly hindered. Without being bound by any theory, it is believed that when LiNO₃ is excluded from the electrolyte, the dense SEI layer was not properly formed. Rather, an unstable, highly porous SEI was formed, where continuous consumption of active materials (e.g., lithium, electrolyte) occurred over time. Thus, the voltage hysteresis increased rapidly for the porous LiF SEI when LiNO₃ was excluded from the electrolyte. On the other hand, the inclusion of LiNO₃ supported the stable formation of the dense layer of the multi-layered artificial SEI structure. It is believed that this occurred from oxidation of polysulfides by the nitrate anion, forming stable and insoluble sulfates/ites (LiₓSO_{y}). The polysulfides were made available in the symmetric cell electrolyte from the LiTFSI salt decomposition. They can also be readily available when a sulfur cathode is used. Polysulfides dissolved on the cathode-side and subsequently reacted with the anode-side lithium metal. Consequently, the combination of the ex-situ formation of the porous layer of the multi-layered artificial SEI structure and careful electrolyte selection appeared to lead to the advantageous performance observed with symmetric cell cycling.

FIGS. 6A and 6B are micrographs showing the morphology of the protective layer in accordance with embodiments of the disclosure. The micrograph in FIG. 6A shows the surface morphology of the porous layer (e.g., porous LiF layer) formed after rinsing the protective layer with solvent in order to dissolve LiI from the protective layer. FIG. 6B shows a cross-section of the same porous layer. Both micrographs were taken prior to cycling using cryo-focused ion beam-scanning electron microscopy (cryo-FIB-SEM) in accordance with conventional techniques. XPS equipped with depth-profiling capabilities confirmed the dissolution of LiI from the protective layer after rinsing with solvent, leaving behind a LiF-rich porous layer.

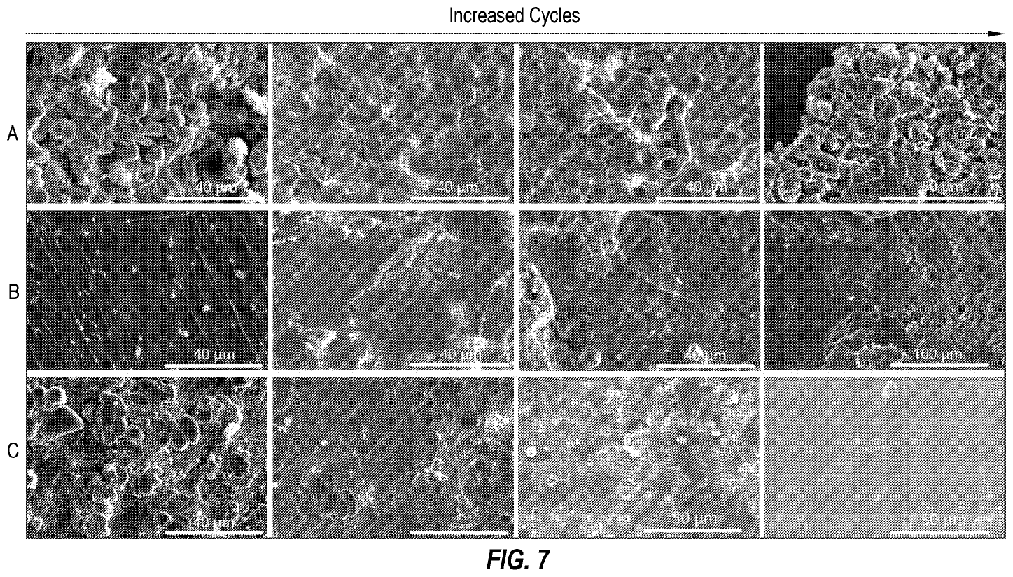

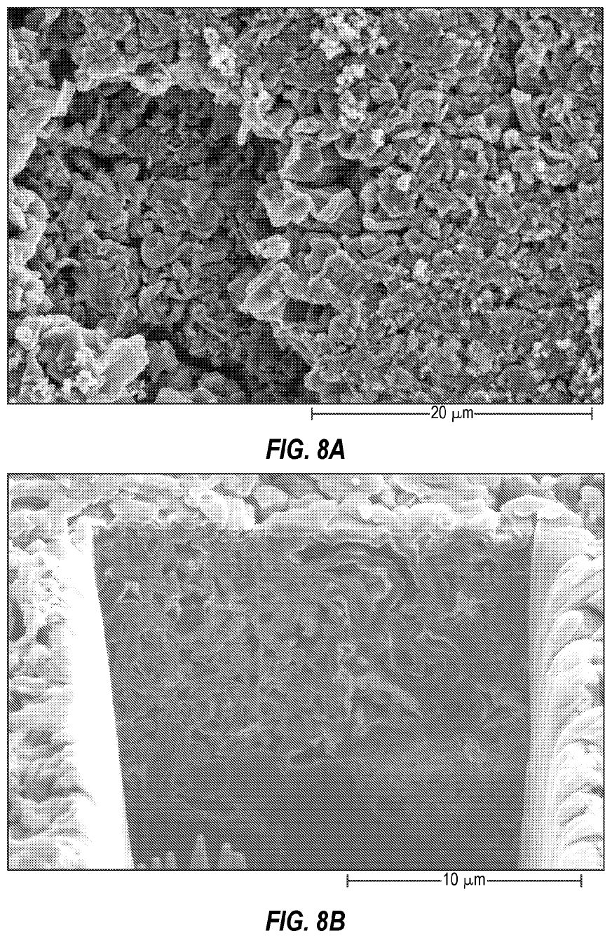

Scanning electron microscopy was also used to analyze the morphological characteristics of the Li metal anodes after they were subjected to a number of cycles (e.g., 2 cycles, 10 cycles, 50 cycles, 100 cycles, 150 cycles, 200+ cycles). The results of this analysis are shown in FIGS. 7-8B. In FIG. 7, the bare Li metal anode is labelled as row A, the dense LiF metal anode is labelled as row B, and the porous LiF metal anode is labelled as row C. The data indicated that the Li metal anode readily produced dendrites, resulting in the short circuiting seen during cycling. The dense LiF SEI (e.g., dense layer) showed cracking and rupturing, allowing further consumption of the underlying lithium metal and electrolyte through redox reactions. This led to a more tortuous pathway that exacted a greater energy cost for lithium ion transfer between electrodes. This was confirmed by the increasing voltage hysteresis for the dense LiF SEI in FIG. 5. The porous LiF metal anodes (e.g., the anodes having a porous layer resulting from LiI dissolution, leaving behind a porous LiF-rich layer) in accordance with the disclosure were highly stable, and thus advantageous for use in electrochemical cells. In FIGS. 8A and 8B, a porous LiF metal anode is shown that was added to electrochemical cells built without LiNO₃ added to the electrolyte. This porous LiF metal anode without LiNO₃ led to highly porous, unstable SEI, which can be seen in the surface morphology shown in FIG. 8A, as well as in the cross-section shown in FIG. 8B. This unstable SEI allowed continuous consumption of lithium metal and electrolyte, creating a more tortuous pathway. This result was similar to that of the dense LiF SEI, where increasing impedance (i.e., cell potential) in FIG. 5 was observed.

Additional non-limiting example embodiments of the disclosure are set forth below.

Embodiment 1. An electrochemical cell, comprising an electrolyte between a cathode and an anode and a protective layer between the anode and the electrolyte, the protective layer comprising a porous layer over the anode and a dense layer over the porous layer, each of the porous layer and the dense layer comprising an inorganic compound, an organic compound, or an inorganic-organic composite.

Embodiment 2. The electrochemical cell of Embodiment 1, wherein the anode comprises lithium, potassium, sodium, potassium, magnesium, or calcium.

Embodiment 3. The electrochemical cell of Embodiment 1 or Embodiment 2, wherein the protective layer comprises one or more of lithium fluoride, lithium bromide, lithium chloride, lithium carbonate, lithium phosphide, lithium phosphate, lithium nitride, lithium nitrate, lithium sulfide, lithium sulfate, thio-lithium superionic conductors, lithium tin phosphorous sulfide, lithium-stuffed garnet, perovskite-type lithium lanthanum titanates, sodium superionic conductors, lithium aluminum titanium phosphate, glass-ceramics, or a combination thereof.

Embodiment 4. The electrochemical cell of any of Embodiments 1-3, wherein the porous layer exhibits a thickness ranging from about 1 micrometer to about 15 micrometers.

Embodiment 5. The electrochemical cell of any of Embodiments 1-4, wherein the dense layer exhibits a thickness of from about 5 nanometers to about 1000 nanometers.

Embodiment 6. An electrochemical cell, comprising: an electrolyte between a cathode and an anode; and a protective layer between the anode and the electrolyte, the protective layer comprising: a porous layer proximal to the anode and comprising an inorganic compound, an organic compound, or an inorganic-organic composite; and a dense layer adjacent to the porous layer and proximal to the electrolyte and comprising an inorganic compound, an organic compound, or an inorganic-organic composite.

Embodiment 7. The electrochemical cell of Embodiment 6, wherein the electrochemical cell comprises a lithium-ion battery, a potassium-ion battery, a sodium-ion battery, a potassium-ion battery, a magnesium-ion battery, or a calcium-ion battery.

Embodiment 8. The electrochemical cell of Embodiment 6 or Embodiment 7, wherein the porous layer exhibits pore sizes within a range of from about 10 nanometers to about 1000 nanometers.

Embodiment 9. The electrochemical cell of any of Embodiments 6-8, wherein the dense layer partially fills pores of the porous layer.

Embodiment 10. The electrochemical cell of any of Embodiments 6-9, wherein the porous layer comprises an inorganic-organic composite comprising lithium fluoride and a polymer.

Embodiment 11. The electrochemical cell of any of Embodiments 6-10, wherein the porous layer comprises an inorganic-organic composite comprising lithium fluoride, lithium iodide, and a polymer.

Embodiment 12. The electrochemical cell of any of Embodiments 6-11, wherein the electrolyte comprises lithium nitrate and at least one of lithium bis(fluorosulfonyl)imide, lithium bis(trifluoro-methanesulfonyl)imide, lithium hexafluorophosphate, or a combination thereof.

Embodiment 13. The electrochemical cell of any of Embodiments 6-12, wherein the porous layer comprises lithium fluoride and the dense layer comprises lithium fluoride.

Embodiment 14. A method of forming an electrochemical cell, comprising: providing a metal anode; forming a porous layer over the metal anode; forming an electrolyte over the porous layer; forming a cathode over the electrolyte; and applying a voltage through the electrochemical cell to form a dense layer on the porous layer.

Embodiment 15. The method of Embodiment 14, wherein forming a porous layer over the metal anode comprises exposing the metal anode to a precursor solution comprising a polymer and an inorganic compound and reacting the polymer and the inorganic compound with the metal anode.

Embodiment 16. The method of Embodiment 14 or Embodiment 15, wherein applying a voltage through the electrochemical cell to form a dense layer on the porous layer comprises in-situ forming the dense layer.

Embodiment 17. The method of Embodiment 14 or Embodiment 15, wherein applying a voltage through the electrochemical cell to form a dense layer on the porous layer comprises ex-situ forming the dense layer.

Embodiment 18. The method of any of Embodiments 14-17, wherein applying a voltage through the electrochemical cell to form a dense layer on the porous layer comprises depositing lithium in pores of the porous layer.

Embodiment 19. The method of any of Embodiments 14-18, wherein applying a voltage through the electrochemical cell to form a dense layer on the porous layer comprises transporting electrons through the lithium.

Embodiment 20. The method of any of Embodiments 14-19, wherein applying a voltage through the electrochemical cell to form a dense layer on the porous layer comprises reacting lithium and the electrolyte.

Although the foregoing descriptions contain many specifics, these are not to be construed as limiting the scope of the disclosure, but merely as providing certain exemplary embodiments. Similarly, other embodiments of the disclosure may be devised that do not depart from the scope of the disclosure. For example, features described herein with reference to one embodiment may also be provided in others of the embodiments described herein. The scope of the embodiments of the disclosure is, therefore, indicated and limited only by the appended claims and their legal equivalents, rather than by the foregoing description. All additions, deletions, and modifications to the disclosure, as disclosed herein, which fall within the meaning and scope of the claims, are encompassed by the disclosure.

1. An electrochemical cell, comprising:
an electrolyte between a cathode and an anode and a protective layer between the anode and the electrolyte, the protective layer comprising a porous layer over the anode and a dense layer over the porous layer, each of the porous layer and the dense layer comprising an inorganic compound, an organic compound, or an inorganic-organic composite.

2. The electrochemical cell of claim 1, wherein the anode comprises lithium, potassium, sodium, potassium, magnesium, or calcium.

3. The electrochemical cell of claim 1, wherein the protective layer comprises one or more of lithium fluoride, lithium bromide, lithium chloride, lithium carbonate, lithium phosphide, lithium phosphate, lithium nitride, lithium nitrate, lithium sulfide, lithium sulfate, thio-lithium superionic conductors, lithium tin phosphorous sulfide, lithium-stuffed garnet, perovskite-type lithium lanthanum titanates, sodium superionic conductors, lithium aluminum titanium phosphate, glass-ceramics, or a combination thereof.

4. The electrochemical cell of claim 1, wherein the porous layer exhibits a thickness ranging from about 1 micrometer to about 15 micrometers.

5. The electrochemical cell of claim 1, wherein the dense layer exhibits a thickness of from about 5 nanometers to about 1000 nanometers.

6. An electrochemical cell, comprising:
an electrolyte between a cathode and an anode; and
a protective layer between the anode and the electrolyte, the protective layer comprising:
a porous layer proximal to the anode and comprising an inorganic compound, an organic compound, or an inorganic-organic composite; and
a dense layer adjacent to the porous layer and proximal to the electrolyte and comprising an inorganic compound, an organic compound, or an inorganic-organic composite.

7. The electrochemical cell of claim 6, wherein the electrochemical cell comprises a lithium-ion battery, a potassium-ion battery, a sodium-ion battery, a potassium-ion battery, a magnesium-ion battery, or a calcium-ion battery.

8. The electrochemical cell of claim 6, wherein the porous layer exhibits pore sizes within a range of from about 10 nanometers to about 1000 nanometers.

9. The electrochemical cell of claim 6, wherein the dense layer partially fills pores of the porous layer.

10. The electrochemical cell of claim 6, wherein the porous layer comprises an inorganic-organic composite comprising lithium fluoride and a polymer.

11. The electrochemical cell of claim 6, wherein the porous layer comprises an inorganic-organic composite comprising lithium fluoride, lithium iodide, and a polymer.

12. The electrochemical cell of claim 6, wherein the electrolyte comprises lithium nitrate and at least one of lithium bis(fluorosulfonyl)imide, lithium bis(trifluoro-methanesulfonyl)imide, lithium hexafluorophosphate, or a combination thereof.

13. The electrochemical cell of claim 6, wherein the porous layer comprises lithium fluoride and the dense layer comprises lithium fluoride.

14. A method of forming an electrochemical cell, comprising:
providing a metal anode;
forming a porous layer over the metal anode;
forming an electrolyte over the porous layer;
forming a cathode over the electrolyte; and
applying a voltage through the electrochemical cell to form a dense layer on the porous layer.

15. The method of claim 14, wherein forming a porous layer over the metal anode comprises exposing the metal anode to a precursor solution comprising a polymer and an inorganic compound and reacting the polymer and the inorganic compound with the metal anode.

16. The method of claim 14, wherein applying a voltage through the electrochemical cell to form a dense layer on the porous layer comprises in-situ forming the dense layer.

17. The method of claim 14, wherein applying a voltage through the electrochemical cell to form a dense layer on the porous layer comprises ex-situ forming the dense layer.

18. The method of claim 14, wherein applying a voltage through the electrochemical cell to form a dense layer on the porous layer comprises depositing lithium in pores of the porous layer.

19. The method of claim 14, wherein applying a voltage through the electrochemical cell to form a dense layer on the porous layer comprises transporting electrons through the lithium.

20. The method of claim 14, wherein applying a voltage through the electrochemical cell to form a dense layer on the porous layer comprises reacting lithium and the electrolyte.
